(19) United States
(12) Patent Application Publication
(10) Pub. No.: US 2009/0249969 A1
(43) Pub. Date: Oct. 8, 2009

(54) PRINTER HAVING INCREASED SOLUTION VOLUME OF PRINTING AND INCREASED PRINT QUALITY AND SPEED

(75) Inventors: M. Benton Free, Saint Paul, MN (US); Daniel W. Hennen, Cottage Grove, MN (US); John S. Huizinga, White Bear Lake, MN (US); Mark D. Fiegen, Roseville, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/062,583

(22) Filed: Apr. 4, 2008

(51) Int. Cl. B41J 3/00

(52) U.S. Cl. 101/93.05

(57) ABSTRACT

A printer for digital printing in which ink is deposited in metered amounts on a substrate. The printer includes a wheel rotatable by a shaft of a motor, an idler disposed in a paint reservoir, and a segment of wire disposed around the wheel and the idler. A computer controls movement of the wire by controlling the rotation of the wheel. As the motor rotates the wheel, ink contained within the paint reservoir coats the wire and is drawn by the wire in front of an air stream, which pulls the ink from the wire and carries it toward the substrate. The wire has features to increase a solution volume of the ink on the wire. The ink is applied to the substrate in vector mode to form well defined fine lines an image and a raster mode to form wider lines less well defined than the fine lines.

### BACKGROUND

Two conventional printing techniques include ink jet printing and screen printing. Ink jet printers work by depositing small droplets of ink in various colors, typically cyan, magenta, yellow and black, on a print medium or substrate to form a color image. Conventional thermal ink jet printing heads include several nozzles and thermal elements. Ink is expelled from the nozzles in a jet by bubble pressure created by heating the ink using the thermal elements while the nozzles and thermal elements are in close proximity. Ink jet print heads use relatively small orifices, valves, and nozzles for depositing the desired quantity and color of ink on the print medium. Therefore, very fine grade inks are required in which particle sizes of the pigments within the inks are kept to a minimum to help keep the orifices, valves, and nozzles of the ink system from becoming clogged.

In screen printing, ink is forced through a design-bearing screen onto the substrate being printed. The screen is made of a piece of porous, finely woven fabric stretched over a wood or aluminum frame. Areas of the screen are blocked off with a non-permeable material, a stencil, which is a negative of the image to be printed. The screen is placed on top of a piece of print substrate, often paper or fabric. Ink is placed on top of the screen, and scraper blade is used to push the ink evenly into the screen openings and onto the substrate. The ink passes through the open spaces in the screen onto the print substrate; then the screen is lifted away. The screen can be re-used for multiple copies of the image, and cleaned for later use. If more than one color is being printed on the same surface, the ink is allowed to dry and then the process is repeated with another screen and different color of ink. Screen printing requires use of inks having a relatively high viscosity to prevent all the ink from simply passing through the screen onto the print substrate.

Accordingly, a need exists for an improved apparatus and method for printing inks.

### SUMMARY

A method, consistent with the present invention, can be used to form a pattern on a substrate. The method includes providing one of the following types of cables: a twisted wire; a braided wire; a porous wire; a rough wire; a nonwoven wire; or a multiple wire. The method also includes coating at least a portion of the exterior surface of the cable with an ink, directing an air stream at the portion of the cable coated with the ink, and electronically controlling advancement and position of the cable through the air stream such that a metered amount of the ink is removed from the exterior surface of the cable and is deposited onto the substrate to form a pattern on the substrate.

An apparatus, consistent with the present invention, can deposit an ink on a substrate. The apparatus includes an electronically controllable drive mechanism and a structure associated with the drive mechanism and movable thereby. The structure includes one of the following types of cables: a twisted wire; a braided wire; a porous wire; a rough wire; a nonwoven wire; or a multiple wire. An ink supply is in communication with the structure for depositing ink on at least a portion of the structure. At least one fluid nozzle having at least one nozzle orifice is positioned and oriented for directing at least one jet of fluid toward at least a portion of the structure to remove an amount of the ink from the structure and direct the amount toward a substrate. The movement of the structure relative to the at least one fluid nozzle substantially controls the amount of the ink removed from the structure, and the amount of the ink directed to the substrate form a pattern on the substrate.

In the apparatus and method, the ink can be applied to the substrate in a vector mode to form fine lines of an image followed by a raster to form lines of the image less well defined than the fine lines.

### BRIEF DESCRIPTION OF THE DRAWINGS

The accompanying drawings are incorporated in and constitute a part of this specification and, together with the description, explain the advantages and principles of the invention. In the drawings,

FIG. 1 is a perspective view of one embodiment of a fluid delivery system or printer;

FIG. 2 is a side view of the fluid delivery system of FIG. 1;

FIG. 3 is a diagram of a system to use the printer to print materials onto a substrate;

FIG. 4A is a diagram illustrating a braided wire;

FIG. 4B is a diagram illustrating a twisted wire;

FIG. 5A is a diagram illustrating a porous wire;

FIG. 5B is a diagram illustrating a rough wire;

FIG. 5C is a diagram illustrating a nonwoven wire;

FIG. 6 is a diagram illustrating a multiple wire; and

FIG. 7 is a diagram illustrating a method of printing using a vector mode and a raster mode.

### DETAILED DESCRIPTION

### Printing System

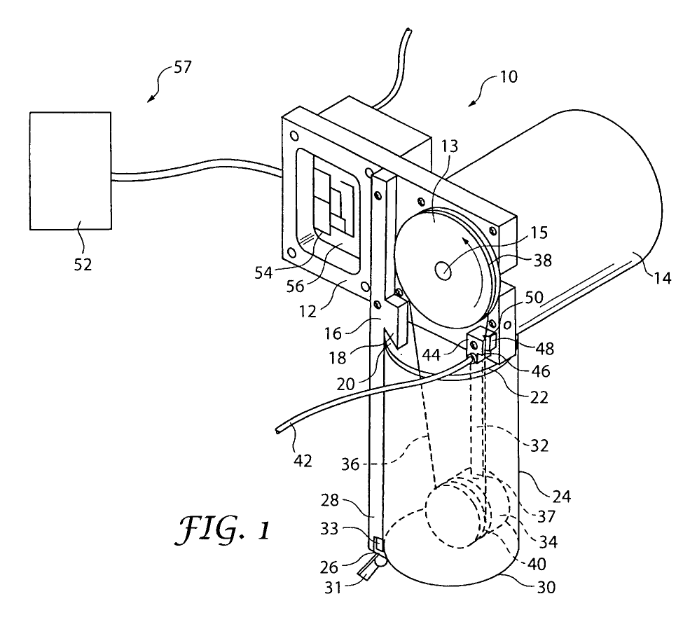

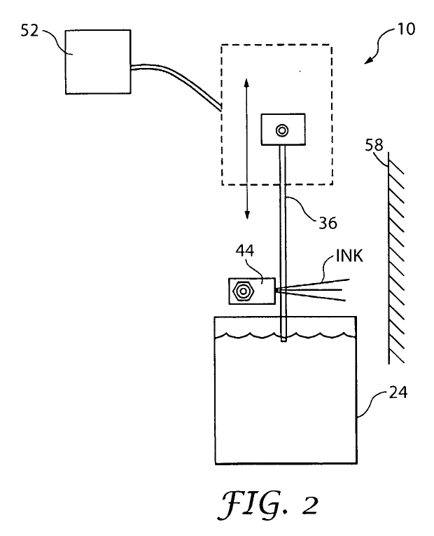

FIG. 1 is a perspective view of one embodiment of the fluid delivery system or printer, generally indicated at 10. FIG. 2 is a side view of the fluid delivery system or printer of FIG. 1. A pulley 13 having a circumscribing groove 38 defined therein is secured to a shaft 15 of a motor 14. An elongate frame member 32 is secured to frame or plate 12 and extends into a reservoir of ink 24. A rotatable or stationary guide 34 is attached to a distal end 37 of elongate frame member 32. Guide 34 is illustrated as a cylindrical, non-rotatable member having a groove 40 circumscribing guide 34 in which a wire cable 36 can slide during rotation of wheel 13. Alternatively, guide 34 can be implemented with a rotatable member. As used herein, the term “cable” or “wire” or “wire cable” or “elongate segment” is meant to include the use of a wire, a cable formed of multiple wires, a rod, a saw tooth wheel, or variations thereof. Wire cable 36 is disposed in groove 38 circumscribing the wheel 13 and in groove 40 circumscribing guide 34.

An elongate reservoir retaining member 16 is attached to plate 12 and includes a flange 18 defining a notch 20 between the flange 18 and elongate reservoir retaining member 16. Notch 20 is configured to receive a top lip 22 of ink reservoir 24. A bottom plate 26 is secured to a distal end 28 of elongate reservoir retaining member 16 with a threaded nut 31 that is threaded onto a threaded shaft 33. Threaded shaft 33 is secured to distal end 28 of elongate reservoir retaining member 16. Bottom plate 26 abuts against the bottom 30 of ink reservoir 24 and holds it between flange 18 and bottom plate 26.

An air supply hose 42 is secured to a nozzle body 44 and supplies air through a nozzle orifice 46 that is aimed at a portion of cable 36. A cable guide 48 defining a longitudinal slot 50 is positioned proximate nozzle orifice 46. Cable 36 rides within slot 50 and is thus held in relative position to nozzle orifice 46 so that air passing therethrough does not substantially move cable 36 from in front of nozzle orifice 46 or cause cable 36 to substantially vibrate. Slot 50 can alternatively include a small rotatable guide.

Rotation of shaft 15 may be controlled by a controller, generally indicated at 57. Any type of controller may be used. In one embodiment, the controller includes circuitry 54 in a module 56 that receives signals from a signal generating device 52, such as a microprocessor or other devices that can supply discrete signals to instruct selective rotation of the shaft 15 of the motor. Circuitry 54 receives a signal(s) from generating device 52 and rotates shaft 15 of the motor according to the signal(s).

In operation, ink contained in reservoir 24 is picked up by wire cable 36 and advanced by rotation of wheel 13, indicated by the arrow, in front of nozzle orifice 46. Fluid that is blown through nozzle orifice 46 disperses or pulls the ink from cable 36 toward the print medium. Depending on the viscosity of the ink in the reservoir, the cross-sectional diameter of cable 36, and the diameter of wheel 13, a relatively precise amount of ink can be dispensed. The ink is dispersed onto a substrate 58, as illustrated in FIG. 2.

The print head in system 10 can include alternative implementations, as shown in FIG. 1A in U.S. Pat. No. 5,944,893 and described in the corresponding text. For example, the print head can include a discontinuous wire, guide 34 can be rotatable, a spring tensioning mechanism can be used, and an air solenoid can be used to turn the air supply on and off.

The fluid delivery system or printer of the present invention is based on printer technology that is described in U.S. Pat. Nos. 5,944,893; 5,972,111; 6,089,160; 6,090,445; 6,190,454; 6,319,555; 6,398,869; and 6,786,971, all of which are incorporated herein by reference as if fully set forth.

As used herein, the term “ink” is meant to include any pigmented material, including, but not limited to, inks, dyes, paints, particle loaded suspensions, or other similarly pigmented liquids.

As used herein, the term “print medium” or “substrate” are meant to include any print medium known in the art, including but not limited to paper, plastic, polymer, synthetic paper, non-woven materials, cloth, metal foil, vinyl, films, glass, wood, cement, and combinations or variations thereof. The print medium or substrate can be a rigid material or a flexible material.

FIG. 3 is a diagram of a system 130 to use the printer to print ink onto a substrate. System 130 includes a print head 148 mounted on a track 142 supported by vertical posts 144 and 146, a wall, or other support. Print head 148 corresponds with printing system 10. A drive unit 134, using a motor, controls movement of print head 148 along track 142 in an x-direction as indicated by arrows 140. A substrate support 150 is located on a track 136, which would be supported by a vertical post, wall, or other support. A drive unit 132, using a motor, controls movement of substrate support 150 along track 136 in a y-direction as indicated by arrows 138. A substrate can be mounted or otherwise affixed to substrate support 150, and a line or pattern can be printed upon the substrate by print head 148. The configuration of the line or pattern is determined by the coordinated movement of print head 148 along track 142 and the substrate on substrate support 150 along track 136.

A computer 100, corresponding with controller 57 and used to implement controller 57, electronically controls print head 148 and drive units 132 and 134 for moving substrate support 150 and print head 148, respectively. Computer 100 can include, for example, the following components: a memory 112 storing one or more applications 114; a secondary storage 120 for providing non-volatile storage of information; an input device 116 for entering information or commands into computer 100; a processor 122 for executing applications stored in memory 112 or secondary storage 120, or as received from another source; an output device 118 for outputting information, such as information provided in hard copy or audio form; and a display device 124 for displaying information in visual or audiovisual form. Computer 100 can optionally include a connection to a network such as the Internet, an intranet, or other type of network.

Computer 100 can be programmed to control movement of print head 148 along track 142 and substrate support 150 along track 136. In particular, computer 100 can be programmed to electronically control movement of print head 148, via drive unit 134, in x-direction 140 laterally across a substrate on substrate support 150, and computer 100 can be programmed to electronically control movement of the substrate on substrate support 150, via drive unit 132, in y-direction 138 vertically with respect to print head 148. Computer 100 also controls print head 148, as described above, for movement of the wire and delivery of the ink from the wire to the substrate. Computer 100 can also be programmed to control an air solenoid in system 10. The use of tracks 136 and 142 for coordinated movement of substrate support 150 and print head 148, respectively, thus effectively functions as an X-Y stage for using the printer to print a wide variety of shapes and configurations of patterns, lines, or other elements. As an alternative, lines or patterns can be printed using one of the following techniques: coordinated movement of print head 148 in the y-direction and substrate support 150 in the x-direction; movement of print head 148 in both the x-direction and y-direction; or movement of substrate support 150 in both the x-direction and y-direction.

Computer 100 can also be programmed to control the printer for radial printing. In particular, a first orifice can direct an air jet at the wheel or wire to remove paint in a purely radial direction, while other orifices supplying air can be angled above the air jet created by the first orifice to help eliminate conical divergence of the paint as it is pulled from the surfaces of the wheel or wire.

As an alternative to the type of printing illustrated by system 130 in FIG. 3, the printer can pattern a substrate in a roll-to-roll process. In such as a process, the substrate is formed as a moving web of material, and the print head would move back and forth in a cross web direction to apply ink to the substrate. As another alternative, the printer can pattern the web of material in a step and repeat manner. In this process, the printer patterns an image onto a section of the substrate and then advances the substrate to new position. The printer then prints an image onto the new section, and the process is repeated.

### Increased Solution Volume of Printing

As described above, the printer uses a wire to carry ink from the ink reservoir to the air jet, which blows the ink off the wire and onto the surface being coated. The quantity and quality of ink applied to the surface depends on the wire feed rate, rheologic properties of the ink, air flow, orifice geometry, and distance from the print head to the surface, among other things. The mechanism for this ink transport is shown in FIGS. 1 and 2. FIG. 3 illustrates an exemplary system for printing a line or pattern on a substrate using the printer.

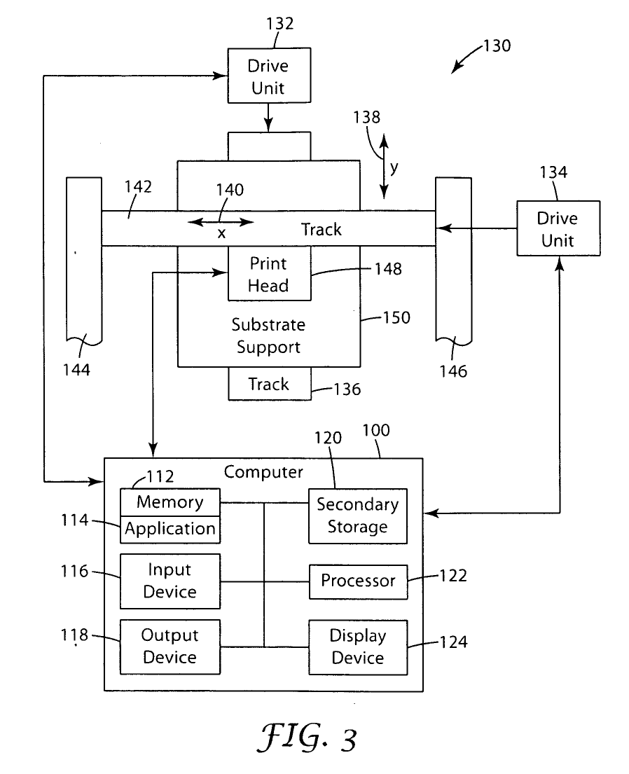

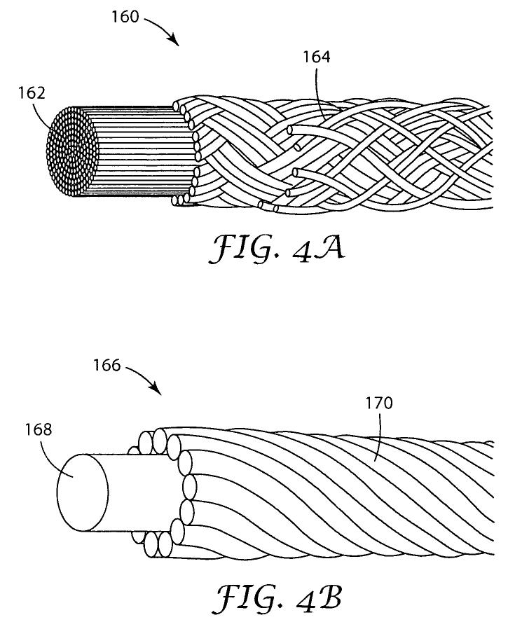

Embodiments of the present invention include techniques to increase the volume of solution or ink delivered by the printer. One technique involves use of a braided or twisted wire as the wire cable 36 described above. The surface area of the wire could be increased by braiding several wires together to create pockets that the solution would stick or adhere to. FIGS. 4A and 4B illustrate, respectively, braided and twisted wires 160 and 166. Wire 160 includes a braided set of wires around a core 162, and wire 166 includes a twisted set of wires 170 around a core 168. Each of the pores in the braid would collect solution and increase the total volume delivered. The volume delivered can be controlled by using larger or smaller pore size wire. This allows for changing the volume of solution delivered by changing the wire, but not the wire diameter. Thus, the geometry of the air jet would not need to change. Braided or twisted wire could possibly also extend the life of the wire in the system due to its increased flexibility.

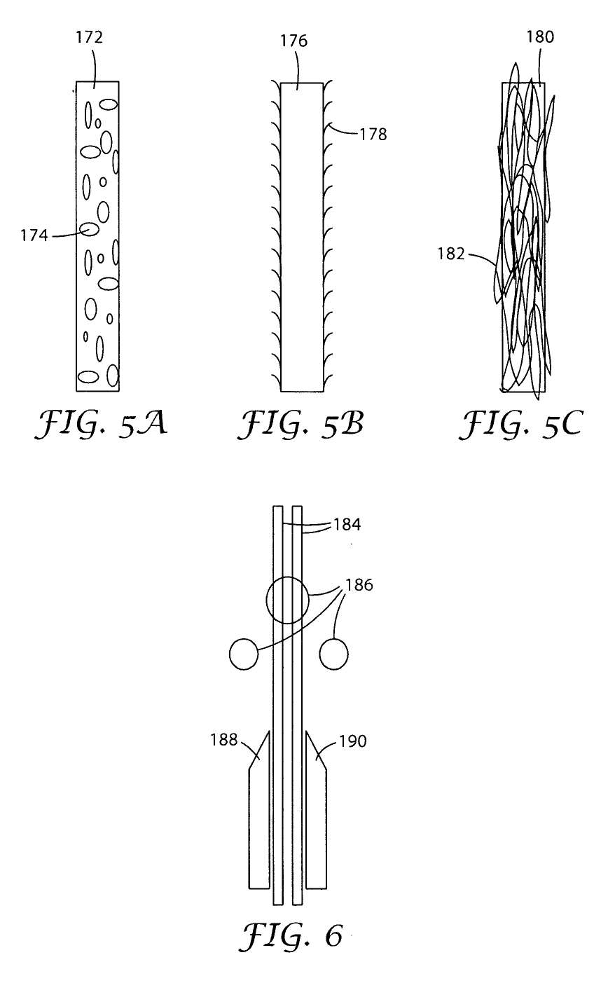

Another technique to increase the solution volume includes use of a fuzzy wire, as wire cable 36 described above, to increase its surface area in order for the wire to hold more solution or ink. FIGS. 5A-5C illustrate, respectively, porous, rough, and nonwoven wires 172, 176, and 180. Wire 172 includes a porous surface 174. Wire 176 includes a rough surface 178. Wire 180 includes a nonwoven surface 182 such as a yarn. These pores or hooks in the wire catch the solution allowing more ink to be held by the wire.

Yet another technique to increase the solution volume includes use of a multiple wire, as wire cable 36 described above. FIG. 6 is a diagram illustrating a multiple wire 184 passing in front of air orifices 186 and between doctor blades 188 and 190. This example illustrates use of a dual wire as multiple wire 184; however, more than two wires can also be used as a multiple wire. The individual wires of multiple wire 184 run in parallel, carrying more solution to the orifice due the bridging of the solution between the two wires. The two wires would also move at the same rate and be spaced closely together in order to allow the printing solution or ink to bridge between them as they move the material past the delivery orifices. The rheology of the solution, the size of the wires, and the distance between the wires determines the amount of solution delivered to the substrate.

An alternative to the multiple wire involves use of a dual orifice with one wire. The dual orifice design has the following features. The idler is turned 90° so that the wire runs parallel to the surface being painted. There are two orifices and doctor blade sets. One orifice is aligned with the wire moving into the paint, and the other orifice is aligned with the wire coming out of the paint. The air supplies to both orifices are controlled by solenoid valves, which are controlled by logic with the motor direction signal and the air on/off signal as inputs. The air is switched between orifices such that, when the wire is forwarding, the first orifice is painting, and when the wire is rewinding the second orifice is painting.

These methods bring a greater volume of the solution to the orifices, thus delivering more solution to the substrate. These methods would still use the same control handles as the printer described above but gain paint volume. The increased paint volume allows an increased amount of material to be applied to the substrate, or conversely the amount of substrate covered with material, with a given amount of wire.

### Increased Print Quality and Speed

Another embodiment of the present invention includes methods to improve the print quality and speed of the printer described above by printing the outline of a solid printed object differently from the fill. One type of traditional printing includes use of an evenly spaced raster pattern. However, this type of patterning can create poor edge quality and is relatively slow. Embodiments of the present invention include several methods described below to address this issue by edging and filling an object differently. These methods could be used in combination or alone to both increase the image quality and increase the print speed.

Fill and edge in different print modes. Most of the unacceptable overspray from the printer is produced when the printer attempts to stop printing a line. This method does not let that occur on the outside of an image. Rather, the edge of the block image is traced with several concentric passes, referred to as a vector mode. This printing creates a wide outline of the block to be printed. The center of the block is filled in a raster pattern, referred to as a raster mode. As an alternative, a vector mode can refer to printing well defined fine lines of the pattern, and the raster mode can refer to printing wider lines less well defined than the fine lines of the pattern. The fine lines can, but not necessarily need be, on the exterior of the image to be printed, and the wider less well defined lines can, but not necessarily need be, on the interior portion of the image.

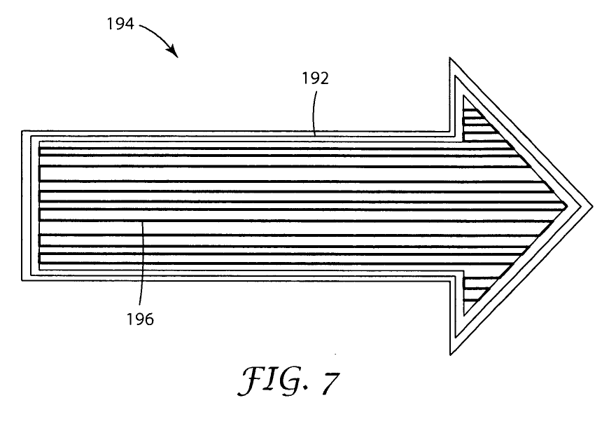

FIG. 7 is a diagram illustrating this method of printing using a vector mode and a raster mode. The outside of image 194 is printed in concentric passes 192 in a vector mode, and the interior is then printed in several passes 196 in a raster mode. The overspray that would normally happen at the edge of the image overlaps with the previously printed outline and does not appear. The raster printed center block creates a smooth, evenly coated surface.

Fill and edge at different heights. The distance the print head is from the surface of the substrate is one factor that determines the amount of overspray of a line, as well as the area covered by a single line. The print head can be positioned very close to the substrate when an object is being outlined, then moved away from the substrate when the object is being filled. The spacing between lines can be increased due to the wider printed lines at larger distances. This method maintains the clean lines at the edges and increase the speed during the center filling of the object where the overspray is not important.

Fill and edge with different wires. The size of the wire is also a factor in determining the quality of the printed image. This method uses two print heads, one loaded with a fine wire (for example, 4 mil piano wire) and the other loaded with a thick wire (for example, 12 mil piano wire). The fine wire can be used for tracing the edges of the object to be printed. The fine wire puts down less paint, creates thin lines, and has less throughput of ink. It is also very delicate. The thick fill wire can be used for the bulk of the printing. It is robust and can print large quantities of paint.

Fill at high air pressure, edge at lower air pressure. The air pressure on the nozzle drastically changes the quality and width of a printed line. The edges could be traced with the air pressure set low (for example, 15 psi). This creates a thin line with little overspray. When the object is being filled, the air pressure could be increased to create wider, fuzzier lines.

Fill at high wire feed, edge at lower wire feed. The wire feed rate determines how much ink is applied per distance traveled. Increasing the feed rate for the fill creates wider lines, speeding up the process.

Fill and edge with different orifices. The shape of the air orifice is a factor in determining the shape and quality of the printed line. The outline of the image can be printed with one orifice that tightly focuses the air, while the fill can use an orifice that spreads the stream out more for larger coverage.

Fill and edge with different orifice movements. One method to increase the area covered during the fill step includes oscillating the orifice. This motion can be very fast relative to the wire speed, creating a very wide line. The motion can be halted during the edging steps in the print.

Fill and edge with different paint rheologies. The rheology of the printed solution has a direct impact on the width and quality of the line. If different solutions are used for the fill and the edge, the quality, coverage, and surface finish can be controlled.

Another technique to improve the print quality involves changing the impinging angle while printing. When the fluid stream is directed in a non-normal angle to the solid printing surface, the lateral spread of the paint on the surface tends toward the direction which is most obtuse and is minimized in the direction which is most acute. The angle of the fluid stream relative to the printed surface is varied in such a manner when printing text and graphics as to take advantage of the preferred lateral spread of paint. Thus, when printing the edge of a character or graphic element, the lateral spread is directed away from the non-printed side and toward the inward (printed) side of the character or graphic element. The angle of tilt can be varied from 0° to 90° relative to the surface. As a solid image is printed in a vector manner, the head of the printer can be angled such that the sharp edge is on the outline of the image, and the rough edge is oriented toward the middle of the image. The rough edge can then be covered over to create a solid image during the next pass of the spray head.

Another method to direct the spray involves adding additional orifices to the print head. These orifices surround the central orifice, and their pressure can be individually controlled. The pressure gradient created when the additional orifices are turned on and off acts to bend the stream of air in a preferred direction.

1. A method of forming a pattern on a substrate, comprising:
providing a cable, wherein the cable comprises one of the following: a twisted wire; a braided wire; a porous wire; a rough wire; a nonwoven wire; or a multiple wire;
coating at least a portion of an exterior surface of the cable with an ink;
directing an air stream at the at least a portion of the cable coated with the ink; and
electronically controlling advancement of the cable through the air stream such that a metered amount of the ink is removed from the exterior surface of the cable and is deposited onto the substrate to form a pattern on the substrate.

2. A method of digital printing to form a pattern on a substrate, comprising:
providing at least one paint injector, the at least one paint injector having a wheel rotatable by a shaft of a motor, an idler at least partially disposed in ink contained in a reservoir, and a wire-like member disposed at least partially around the wheel and the idler, wherein the wire-like member comprises one of the following: a twisted wire; a braided wire; a porous wire; a rough wire; a nonwoven wire; or a multiple wire;
advancing the wire-like member with the motor to apply a coating of the ink to the wire-like member;
electronically controlling the position of the at least one paint injector relative to the surface and electronically controlling advancement of the wire-like member through the fluid stream; and
directing the fluid stream at the coated portion of the wire-like member, while controlling the position of the paint injector and the advancement of the wire-like member, thereby removing at least a portion of the ink from an exterior of the wire-like member and depositing it onto a substrate to form a pattern on the substrate.

3. An apparatus for forming a pattern on a substrate, comprising:
an electronically controllable drive mechanism;
a structure associated with the drive mechanism and movable thereby, wherein the structure comprises one of the following: a twisted wire; a braided wire; a porous wire; a rough wire; a nonwoven wire; or a multiple wire;
an ink supply in communication with the structure for depositing ink on at least a portion of the structure; and
at least one fluid nozzle having at least one nozzle orifice positioned and oriented for directing at least one jet of fluid toward at least a portion of the structure to remove an amount of the ink from the structure and direct the amount toward a substrate,
wherein movement of the structure relative to the at least one fluid nozzle substantially controls the amount of the ink removed from the structure, and wherein the amount of the ink directed to the substrate forms a pattern on the substrate.

4. The apparatus of claim 3, further including a biasing device associated with the wire to maintain tension in the wire.

5. The apparatus of claim 4, further including a mechanical metering device in contact with the wire for removing an amount of the ink from the wire before the wire passes in front of the at least one orifice.

6. A method of forming a pattern on a substrate, comprising:
providing a cable;
coating at least a portion of an exterior surface of the cable with an ink;
directing an air stream at the at least a portion of the cable coated with the ink;
electronically controlling advancement of the cable through the air stream such that a metered amount of the ink is removed from the exterior surface of the cable and is deposited onto the substrate to form a pattern on the substrate; and
applying the ink to form the pattern using a vector mode to print fine lines of the pattern and a raster mode to print lines of the pattern less well defined than the fine lines.

7. The method of claim 6, wherein the applying step comprises using the vector mode to print an outside portion of the pattern and the raster mode to print an interior portion of the pattern.

8. A method of digital printing to form a pattern on a substrate, comprising:
providing at least one paint injector, the at least one paint injector having a wheel rotatable by a shaft of a motor, an idler at least partially disposed in ink contained in a reservoir, and a wire-like member disposed at least partially around the wheel and the idler;
advancing the wire-like member with the motor to apply a coating of the ink to the wire-like member;
electronically controlling the position of the at least one paint injector relative to the surface and electronically controlling advancement of the wire-like member through the fluid stream;
directing the fluid stream at the coated portion of the wire-like member, while controlling the position of the paint injector and the advancement of the wire-like member, thereby removing at least a portion of the ink from an exterior of the wire-like member and depositing it onto a substrate to form a pattern on the substrate; and
applying the fluid stream to form the pattern using a vector mode to print fine lines of the pattern and a raster mode to print lines of the pattern less well defined than the fine lines.

9. The method of claim 8, wherein the applying step comprises using the vector mode to print an outside portion of the pattern and the raster mode to print an interior portion of the pattern.
